(19) United States
(12) Patent Application Publication
(10) Pub. No.: US 2024/0375208 A1
(43) Pub. Date: Nov. 14, 2024

(54) METHOD FOR DETERMINING A GEOMETRICAL OUTCOME VARIABLE AND/OR A QUALITY FEATURE OF A WELD SEAM ON A WORKPIECE

(71) Applicant: TRUMPF Laser- und Systemtechnik GmbH, Ditzingen (DE)

(72) Inventors: Patrick Haug, Unteriflingen (DE); Tim Hesse, Ditzingen (DE); Nicolai Speker, Pleidelsheim (DE); Philipp Scheible, Illingen (DE)

(21) Appl. No.: 18/774,977

(22) Filed: Jul. 17, 2024

Related U.S. Application Data
(63) Continuation of application No. PCT/EP2023/050510, filed on Jan. 11, 2023.

(30) Foreign Application Priority Data
Jan. 18, 2022 (DE) 10 2022 101 093.7

(51) Int. Cl. B23K 26/03; B23K 26/244; B23K 31/12

(52) U.S. Cl. CPC B23K 26/032; B23K 26/244; B23K 31/125

(57) ABSTRACT

A method for determining at least one geometrical outcome variable and/or at least one quality feature of a weld seam on at least one workpiece includes scanning the weld seam using a measurement beam during laser beam welding of the weld seam in order to acquire data points. The measurement beam is moved along at least one measurement path on the weld seam. The acquired data points indicate a height and/or a depth of the weld seam in relation to a workpiece surface of the at least one workpiece. The method further includes determining the at least one geometrical outcome variable and/or the at least one quality feature by evaluating the acquired data points.

### CROSS REFERENCE TO RELATED APPLICATIONS

This application is a continuation of International Application No. PCT/EP2023/050510 (WO 2023/138960 A1), filed on Jan. 11, 2023, and claims benefit to German Patent Application No. DE 10 2022 101 093.7, filed on Jan. 18, 2022. The aforementioned applications are hereby incorporated by reference herein.

### FIELD

Embodiments of the invention relate to a method for determining at least one geometrical outcome variable and/or at least one quality feature of a weld seam, and to a device for determining at least one geometrical outcome variable and/or at least one quality feature of a weld seam.

### BACKGROUND

It is desirable to test the outcome of a laser beam welding process. Such an outcome test includes for example acquiring geometrical variables, for instance a welding depth or seam width, of the weld seams generated by the laser beam welding process.

In this regard, destructive tests downstream of the laser beam welding process are known from the prior art, in particular micrography of the weld seam, in order to test the weld seam outcome with the aid of geometrical variables or quality features. It is further known to monitor process quality features by a visual inspection by means of a camera.

Known downstream testing methods are time-consuming and sometimes require destruction of the weld seam, so that they are suitable only for random testing. In the case of visual inspection that is not nondestructive by means of a camera, not all geometrical outcome variables and quality features can be tested.

### SUMMARY

Embodiments of the present invention provide a method for determining at least one geometrical outcome variable and/or at least one quality feature of a weld seam on at least one workpiece. The method includes scanning the weld seam using a measurement beam during laser beam welding of the weld seam in order to acquire data points. The measurement beam is moved along at least one measurement path on the weld seam. The acquired data points indicate a height and/or a depth of the weld seam in relation to a workpiece surface of the at least one workpiece. The method further includes determining the at least one geometrical outcome variable and/or the at least one quality feature by evaluating the acquired data points.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic cross-sectional view through a device according to one exemplary embodiment of the invention during the laser beam welding;

FIG. 2 shows a corresponding scan field of scanner optics of the device of FIG. 1 with a measurement path indicated, according to some embodiments;

FIG. 3 shows a corresponding scan field of scanner optics of the device of FIG. 1 with an alternative measurement path to FIG. 2, according to some embodiments;

FIG. 4a shows a cloud of the data points acquired by scanning along the measurement path of FIG. 2, according to some embodiments;

FIG. 4b shows a plan view of the weld seam generated along the measurement path of FIG. 2, according to some embodiments; and

FIG. 4c shows a micrograph through the weld seam of FIG. 4b, according to some embodiments.

### DETAILED DESCRIPTION

Embodiments of the present invention provide an improved method and an improved device for determining geometrical outcome variables and/or quality features of weld seams on workpieces, which in particular allow nondestructive and rapid testing of weld seams.

Accordingly, a method is provided for determining at least one geometrical outcome variable and/or at least one quality feature of a weld seam on at least one workpiece, wherein the method is characterized by the following steps:
(a) scanning the weld seam by means of a measurement beam during laser beam welding of the weld seam in order to acquire data points, the measurement beam being moved along at least one measurement path on the weld seam and the acquired data points indicating a height and/or depth of the weld seam in relation to a workpiece surface of the at least one workpiece, and
(b) determining the at least one geometrical outcome variable and/or the at least one quality feature by evaluating the data points acquired previously, i.e. in step (a).

Consequently, the method according to embodiments of the invention allows testing of the weld seam that takes place in parallel, or simultaneously, with the laser beam welding. In other words, the method according to embodiments of the invention is an online method, the term online referring to the fact that the method takes place at least partially or fully during the laser beam welding process for generating the weld seam. This allows online monitoring of the welding process by means of the at least one geometrical outcome variable and/or the at least one quality feature, which on the one hand significantly reduces the time required for testing the weld seam and on the other hand allows accurate testing of the weld seam, as will be explained in more detail below.

In the method according to embodiments of the invention, step (b) may also take place during the laser beam welding of the weld seam. In principle, steps (a) and (b) may take place substantially simultaneously or directly with one another.

The cycle time for generating and testing the weld seam may thereby be further reduced. Further, online adjustment of the laser beam for the laser beam welding may thereby preferably be made possible on the basis of the geometrical outcome variables and/or quality features of the weld seam that have been determined, as will be explained in more detail below. The online adjustment may, however, also take place only on the basis of the acquired data points and not (also) on the basis of the geometrical outcome variables and/or quality features that have been determined. The method according to embodiments of the invention may to this extent, and furthermore, also comprise welding of the weld seam by means of a laser beam, or by the laser beam welding, as a further step.

It is of course possible that a plurality of geometrical outcome variables and/or quality features of the weld seam are determined by means of the method according to embodiments of the invention, in order to allow accurate testing of the weld seam in respect of its quality. A geometrical outcome variable means here in particular a quantitatively measurable variable of the weld seam, or of its geometry. A quality feature, on the other hand, means a qualitative feature which, although it may be measurable quantitatively, can however be output primarily as a qualitative variable, quantitative indication of this feature also being possible secondarily. Such a quality feature may relate to an imperfection, for example a pore in the weld seam, which should not normally occur. In the case of such a pore, the quality feature is qualitative, namely that a pore is present in the weld seam. Quantitatively, the quality feature of the pore may also be specified by the size of the pore and/or site of the pore in the weld seam. To this extent, a quality feature relates to the fact that a predetermined imperfection is or is not present in or around the weld seam and in particular, if it is present, how large the imperfection is.

Since the scanning of the weld seam takes place during its generation, the term weld seam is to be understood in the broader sense, that is to say it is not restricted to an already produced weld seam but covers in particular the already produced weld seam as well as the weld seam being generated, in particular a vapour capillary and a weld pool, as will be explained in more detail below.

In step (a), scanning of the weld seam during the laser beam welding is provided. Consequently, the weld seam may be scanned not, or not only, in a solidified part but in a currently still liquid part of the material of the at least one workpiece. In particular, the at least one measurement path may extend along a vapour capillary (keyhole) of the weld seam and/or along a weld pool (surrounding the vapour capillary) of the weld seam. The geometry or shape of the vapour capillary may thereby be measured. By the acquired data points of the vapour capillary and/or of the weld pool, a number of different geometrical outcome variables of the weld seam may be evaluated during the laser beam welding process, and these also allow readjustment of the laser beam during the laser beam welding process. The measurement of the vapour capillary will also be referred to herein as keyhole shape measurement.

Alternatively or, preferably, in addition, it is possible that the at least one measurement path extends along a substantially solidified part of the weld seam. In this way, various geometrical outcome variables of the already substantially solidified part of the weld seam may also be recorded, advantageously in one run with or along a common measurement path along the vapour capillary and/or the weld pool of the weld seam. The weld seam is regarded as substantially solidified in a part when it is already cooled to such an extent that no further shape change of the weld seam takes place in this part. The measured data points are then definitive, or a band of data points acquired in the thickness or depth direction of the workpiece is narrow.

It is advantageous for the at least one measurement path to extend along an unwelded part of the workpiece surface, the vapour capillary, the weld pool and the solidified part of the weld seam. The unwelded part of the workpiece surface means, in particular, a part of the workpiece surface lying in front of the vapour capillary in a forward feed direction of the laser beam. In this way, different geometrical outcome variables and/or quality features, which are specific for the respective portion of the weld seam, may be determined in one scan run along a measurement path and therefore efficiently.

For the evaluation, it is advantageous that the data points acquired along the vapour capillary and/or the weld pool are subdivided for the evaluation into at least two different predefined regions, which are evaluated separately. Thus, it has been found that preferably different, previously identified regions should advantageously be evaluated for various geometrical outcome variables and quality features. These regions may for example be a region of the weld pool in front of the vapour capillary, an edge of the vapour capillary, a capillary front of the vapour capillary, a deepest location or deepest region of the vapour capillary, a capillary rear wall and/or a region of the weld pool behind the vapour capillary. For the respective data points in these regions, at least one specific quality feature and/or at least one specific geometrical outcome variable may respectively be determined, as will be explained in more detail below by way of example in relation to the description of the figures.

In particular, the at least one measurement path may extend along the weld seam and/or transversely, in particular orthogonally, with respect to the weld seam. The measurement path may in particular be a straight measurement line. Thus, the measurement path along the weld seam may be used to acquire data points along or counter to the forward feed direction. The measurement path transverse with respect to the weld seam, on the other hand, makes it possible to determine data points transversely, in particular orthogonally, with respect to the forward feed direction. The measurement path transverse with respect to the weld seam in this case may in particular extend through the vapour capillary, in particular, a deepest location or deepest point of the vapour capillary, so as to make it possible to determine geometrical outcome variables and/or quality features inside the vapour capillary and transversely, in particular orthogonally, with respect to the forward feed direction or the longitudinal extent of the weld seam, which coincides therewith.

A length of the measurement path longitudinally with respect to the weld seam may—depending on the welding task—be for example between 1 mm and 10 mm. It may be advantageous for the end points of the measurement path of the measurement beam respectively to lie in a region of the workpiece surface in which the workpiece has a solid physical state. In other words, the end points of the straight measurement lines oriented longitudinally with respect to the weld seam may advantageously lie respectively outside the weld pool and the vapour capillary, namely in front or behind. It may in this case be advantageous for a first end point of the straight measurement lines to be arranged by a predeterminable maximum amount, for example at most 0.5 mm or at most 1 mm, in front of the front end of the weld pool and of the vapour capillary, and that a second end point of the straight measurement lines is arranged by a predeterminable maximum amount, for example at most 1 mm or at most 2 mm, behind the rear end of the weld pool. On the basis of the measurement data collected along the measurement path, the length of the measurement path may be adapted to the actual length of the weld pool. In this way, the movement amplitude of the measurement beam, and therefore the measurement region, may be adapted efficiently to the actual situation—for example in the event of a variation of the forward feed speed.

Advantageously, the measurement beam may be moved along the at least one measurement path along the weld seam counter to a forward feed direction of a laser beam for generating the weld seam. The measurement beam may in this case begin on the unwelded part of the workpiece surface, pass through the vapour capillary and the weld pool, and end on the solidified part of the weld pool.

It is further possible that the measurement beam is moved alternately along the measurement path extending along the weld seam and the measurement path extending transversely with respect to the weld seam. Alternately in this case refers in particular to the fact that along the generated weld seam or forward feed direction, a plurality of measurements take place by means of the measurement beam respectively transversely and along the weld seam. In this way, the weld seam may advantageously be scanned longitudinally and transversely, in particular, in the form of a measurement cross with transversely and longitudinally extending straight measurement lines, which is in particular repeated along the weld seam or the forward feed direction of the laser beam, and this makes it possible to acquire data points along the weld seam and transversely with respect to the weld seam so that more geometrical outcome variables and/or quality features can be acquired.

Preferably, the measurement path extending transversely with respect to the weld seam is in this case aligned with the aid of data points of a measurement path previously extending longitudinally along the weld seam. Alternatively, the measurement path extending longitudinally with respect to the weld seam is preferably aligned with the aid of data points of a measurement path previously extending transversely along the weld seam. The aforementioned measurement cross may thus be aligned optimally, in particular inside a deepest location of the vapour capillary. The deepest location or deepest point of the vapour capillary may thus be acquired from the data points that have been acquired by the scanning along the measurement path which extends longitudinally along the weld seam, and this may be employed for the subsequent scanning along the measurement path extending transversely with respect to the weld seam, which then extends through this deepest location.

Advantageously, the method may further comprise the step of carrying out an adjustment calculation, in particular fitting, of the acquired data points. In this way, the determination according to step (b) may straightforwardly be carried out, or at least assisted. In other words, the determination of the at least one geometrical outcome variable and/or of the at least one quality feature may take place or be assisted by means of the adjustment calculation. For example, different data points in the same region of the weld seam may be evaluated quantitatively by the adjustment calculation.

The at least one geometrical outcome variable may be at least one of: a welding depth (EST), a seam overfill, a weld pool length (L5), a bonding cross section (AQ), a seam width (NB), a seam micrograph shape or a combination of at least two of the aforementioned. The at least one quality feature may be at least one of: a crack, a spatter, a pore or a combination of at least two of the aforementioned.

In particular, in step (b), for data points acquired along the solidified part of the weld seam, at least one of: an undercut and/or at least one seam collapse of the weld seam may be determined as the at least one geometrical outcome variable and/or the at least one quality feature.

As mentioned above, the acquired data points may preferably be used to readjust a laser beam during the laser beam welding. In particular, angle errors of the laser beam relative to the workpiece surface in a scan field of scanner optics, by which the laser beam is aligned with the workpiece surface, may thereby be corrected automatically. Such angle errors may result from a change in the working distance or an offset between the scanner optics of the laser beam and the workpiece surface, and may be identified by means of the data points of the weld seam and used for readjustment of the laser beam. The readjustment may take place by a corresponding adjustment of the scanner optics, in particular by means of at least one movement, in particular rotation, of a minor inside the scanner optics.

Preferably, the measurement beam may pass through scanner optics, the measurement beam being moved along the at least one measurement path by moving, in particular rotating, at least one mirror of the scanner optics. As explained above, the laser beam may also be aligned and moved inside a scan field by means of scanner optics. The same scanner optics may in this case be used for the measurement beam and the laser beam, or different scanner optics may be used for the measurement beam and the laser beam. Different scanner optics may have at least partially or fully overlapping scan fields. Preferably, the measurement beam may be moved by means of first scanner optics according to the predefined measurement path, in which case the moving measurement beam may be coupled into second scanner optics of the (processing) laser beam so that the final movement of the measurement beam on the workpiece surface is additionally aligned with the movement of the processing laser beam.

In particular, the measurement beam may be an OCT measurement beam of an OCT sensor system. An OCT sensor system means an optical coherence tomography (OCT) sensor system. With the measurement beam generated by the OCT sensor system, a short measurement time and high accuracy may be achieved, which in turn has an advantageous effect on the welding accuracy and allows the cycle time to be reduced further.

Embodiments of the present invention also provide a device for determining at least one geometrical outcome variable and/or at least one quality feature of a weld seam on at least one workpiece. The device comprises a scanner unit, which is adapted to scan a weld seam by means of a measurement beam during laser beam welding of the weld seam and to move the measurement beam along at least one measurement path on the weld seam. The device further comprises an acquisition unit for acquiring data points from the scan process of the scanner unit, the acquired data points indicating a height and/or depth of the weld seam in relation to a workpiece surface of the at least one workpiece. The device also comprises an evaluation unit for determining the at least one geometrical outcome variable and/or the at least one quality feature by evaluating the previously acquired data points.

The features described herein in respect of the method according to embodiments of the invention may of course also be applied in respect of the device according to embodiments of the invention, and vice versa. In particular, the device may be adapted to carry out the method according to embodiments of the invention.

The device may further comprise a laser beam unit for the laser beam welding of the weld seam. In this way, besides measuring or scanning the weld seam and acquiring and evaluating the data points, the device may also carry out the laser beam welding itself in parallel with the scanning Further, the device may also comprise a control unit for controlling the laser beam welding, in particular moving or guiding the laser beam along the workpiece surface. The control unit may be adapted to control the laser beam at least also on the basis of the acquired data points in order to allow the readjustment already mentioned above of the laser beam when angle errors are found.

As mentioned above, the scanner unit may also be assigned scanner optics which span a scan field for the measurement beam. Further, these scanner optics or further scanner optics of the device may be provided for the laser beam unit.

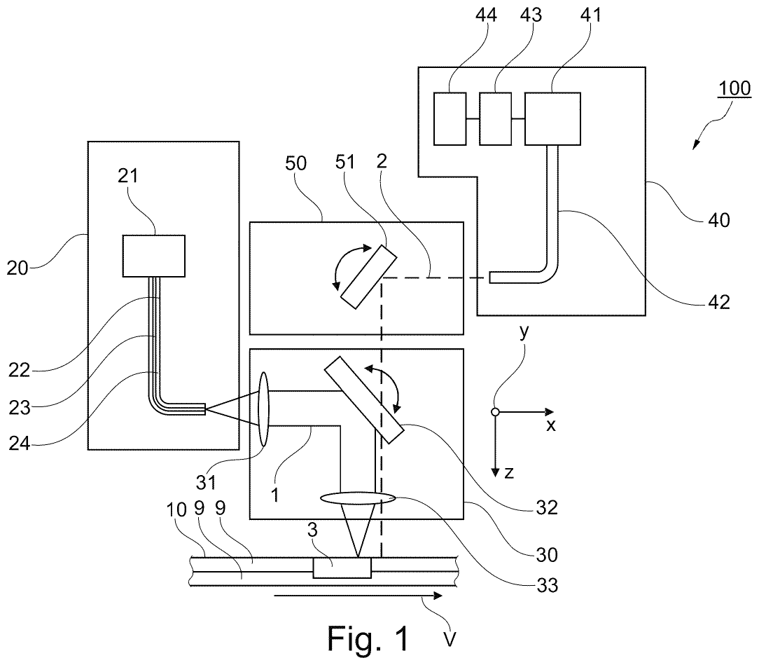

FIG. 1 shows a device 100 in the form of a scanner welding device for joining the two workpieces 9 shown to one another by means of scanner welding.

In order to carry out the welding process, the device 100 comprises the laser beam unit 20 shown in FIG. 1 and first scanner optics 30 assigned to the laser beam unit 20. These optics may be arranged fully or partially in a laser processing head (not shown) of the device 100, which head may in turn be displaceable by means of a movement apparatus (not shown) of the device 100, for instance a robot arm. In principle, however, the first scanner optics 30 allow a forward feed of the laser beam 1 generated by the laser beam unit 20 inside the processing field, or scan field, covered by this unit.

The laser beam unit 20 comprises a laser beam source 21, which may for example be an infrared laser or a VIS laser. By this laser beam source 21, laser radiation 1 is generated and coupled into a cable, or a fibre, which in the present case is formed by a 2-in-1 fibre-optic cable 22 that for its part comprises an inner fibre core 23 and an outer fibre core 24, or a ring fibre, which is arranged around the inner fibre core 23. From the fibre-optic cable 22, a laser beam 1 or laser beams 1 is or are emitted onto the first scanner optics 30.

The first scanner optics 30 comprise a collimation lens 31, a rotatable mirror 32 and a focusing lens 33. By rotating the minor 32, the laser beam 1 can be advanced or displaced on a workpiece surface 10 of the upper of the two workpieces 9 in the forward feed direction v shown, in order to provide laser beam welding along the trajectory predefined by the forward feed direction v by means of the high-energy laser beam 1. The laser beam 1 is in this case displaced along the x-y plane of the x,y,z coordinate system shown in FIG. 1.

The device 100 further has a scanner system 40 with a scanner unit 41, an acquisition unit 42 and an evaluation unit 43, which are respectively shown here by way of example as individual units but may in principle also be arranged in one or two common hardware components by software and/or hardware implementation of their functions. The scanner system 40 may in particular be configured as an OCT sensor system.

The scanner unit 41 emits a measurement beam 3, in particular an OCT measurement beam, which passes through second scanner optics 50 that are shown here by way of example only with one mirror 51, although they may also have more than one minor 51 and other components, for example lenses. As an alternative to the second scanner optics 50, the measurement beam 3 may also pass through the first scanner optics 30. For this purpose, the laser beam 1 may for example be paused during this. Advantageously, however, the laser beam 1 and the measurement beam 2 may be directed onto the workpiece surface 10 in parallel, that is to say simultaneously.

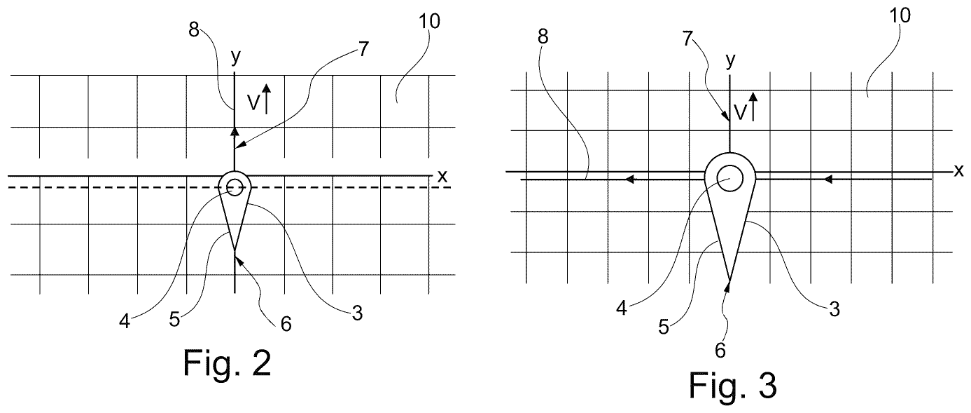

By means of the measurement beam 2, the weld seam 3 generated during the laser beam welding process by the laser beam 1 can now be scanned. The measurement beam 2 may in this case be moved along at least one measurement path 8 (see FIG. 2, 3) on the weld seam 3.

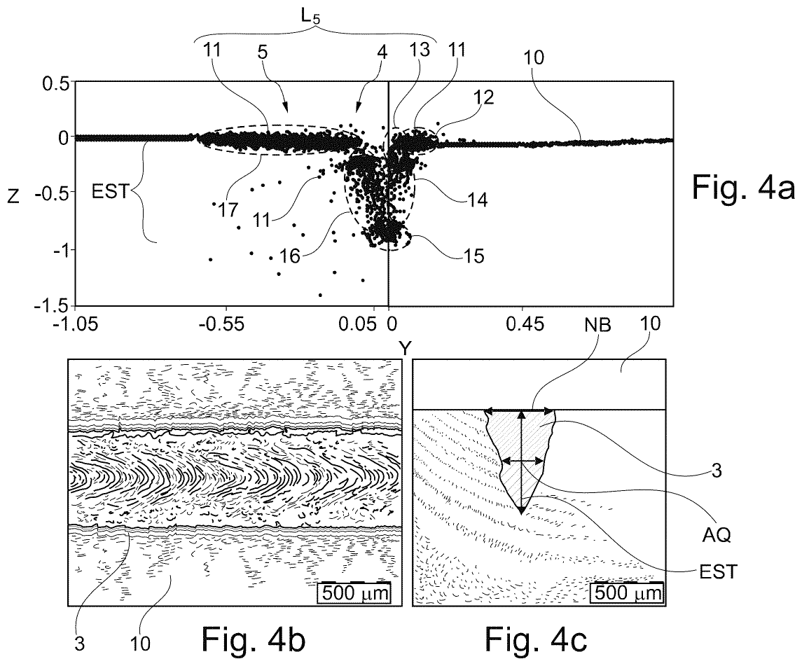

By the acquisition unit 42 connected to the scanner unit 41, the scanner system 40 can acquire data points 11 (see FIG. 4) from the scan process of the scanner unit 41. The data points 11 indicate a height and/or depth of the weld seam 3 in relation to the workpiece surface 10 or, in other words, a profile in the z direction of the weld seam 3, which extends perpendicularly with respect to the x,y plane spanned by the workpiece surface 10.

By the evaluation unit 43 in turn connected to the acquisition unit 42, geometrical outcome variables and quality features of the weld seam 3 are determined by evaluating the previously acquired data points 11. The data point acquisition and the determination of the geometrical outcome variables and quality features of the weld seam 3 may also in this case take place online, that is to say in parallel with the laser beam welding process.

FIGS. 2 and 3 respectively show scan fields, which cover the workpiece surface 10 and are correspondingly covered by the two scanner optics 30, 50. FIG. 2, 3 respectively show different measurement paths 8 in the form of straight measurement lines that the measurement beam 2 follows. They also show the forward feed direction v of the laser beam 1 along the y axis shown.

The measurement path 8 of FIG. 1 extends along the weld seam 3, or coincides with the forward feed direction v of the laser beam 1. In particular, the measurement path 8 extends along an unwelded part 8 of the workpiece surface 10, the weld pool 5 of the weld seam 3, the vapour capillary 4 of the weld seam 3 and a solidified part 6 of the weld seam 3. Other than as indicated by the arrows of the measurement path 8 in FIG. 1, the measurement beam 2 may be displaced along the measurement path 8 in a direction extending counter to the forward feed direction v.

Conversely, the measurement path 8 of FIG. 3 extends transversely, in particular perpendicularly, with respect to the forward feed direction v, or along the extent of the weld seam 3, and the measurement path 8 of FIG. 1. The measurement path 8 of FIG. 3 likewise passes through the vapour capillary 4 and the weld pool 5 surrounding the latter.

The two measurement paths 8 of FIGS. 2 and 3 may respectively be followed alternately by the measurement beam 2 along the weld seam 3 being generated. The y position for the measurement path 8 extending transversely with respect to the forward feed direction v may in this case be aligned with the aid of the previously performed scan along the measurement path 8 extending along the weld seam 3, or the data points 11 thereby acquired. In particular, the deepest location, or the data point 11 with the greatest depth in relation to the workpiece surface 10, may be acquired and used for the measurement path 8 extending transversely with respect to the weld seam 3, so that it extends through the deepest location of the vapour capillary 4.

FIG. 4a shows, in a z,y diagram, a cloud of data points 11 that were acquired by scanning the weld seam 3 along the measurement path 8 of FIG. 2, that is to say along the forward feed direction v and in particular counter to the forward feed direction v. For the workpieces 9, construction steel was used by way of example here and by way of example an average laser power Pav=300 W, a forward feed speed v=3 m/min and a beam diameter d0=85 μm were used as parameters of the laser beam 1. In this regard, FIG. 4a represents a height profile of the weld seam 3 along the y axis or forward feed direction v at the time of the measurement, which may also be referred to as a keyhole shape measurement since it records the shape of the keyhole, or the vapour capillary 4.

FIG. 4b shows the weld seam 3 associated with FIG. 4a in a plan view, and FIG. 4c shows an associated micrograph of the weld seam 3.

As clearly shown by FIG. 4a, a multiplicity of different geometrical outcome variables and quality features may be determined by evaluating the acquired data points 11.

For this purpose, the weld seam 3 may be subdivided into a plurality of regions 12, 13, 14, 15, 16, 17 in the region of the vapour capillary 4 and of the weld pool 5, in which case six regions 12, 13, 14, 15, 16, 17 may preferably be distinguished and a corresponding division may take place as is shown in FIG. 4a. By evaluating the data points 11 of the measurement beam 2 in the evaluation unit 43 in the six regions, correlations may be found with geometrical outcome variables and quality of the weld seam 3.

Thus, an estimation of the weld pool length L5 may take place from the region 12 as far as the region 17 by the keyhole shape measurement. The boundary from the solid workpiece 9, in particular sheet metal, to the liquid melt can respectively be identified, and thus delimited, with the aid of an increase in the bandwidth of data points 11 in the z direction. The length of the measurement path 8 may be increased with high laser powers and/or forward feed speeds of the laser beam 1 in order to detect the entire weld pool 5.

The region 12 comprises the weld pool 5 in front of the vapour capillary 4. With the aid of the region 12, an estimation of the weld pool dynamics in front of the vapour capillary 4 is possible. A dynamic weld pool 5 is distinguished by a large height difference of the measurement points or data points 11 of the weld pool 5, and may be interpreted as a quality feature.

The region 13 comprises an edge of the vapour capillary 4. Here, it is assumed that no spatters occur on the front edge of the capillary opening of the vapour capillary 4. The melt droplets reflect the measurement beam 3 in this region and give rise to data points 11. By evaluating these data points 11 in the region 13, the presence of undesired spatters can be determined, which may be regarded as an unfavourable quality feature.

The region 14 comprises a capillary front of the vapour capillary 4. In this region 14, the capillary stability may be determined as a quality feature of the vapour capillary 4 with the aid of the acquired data points 11. Specifically, a fluctuating capillary front manifests itself in a wide band of data points 11 in the region 14 of the capillary front. The inclination of the vapour capillary 4 may also have an additional influence on the capillary stability, and may also be included here in the evaluation.

The region 15 comprises the deepest location or deepest region of the vapour capillary 4. In the region 15, the welding depth EST may be acquired as the difference between the height of the recorded workpiece surface 10 and one or more deepest data points 11 of the region 15. With the aid of the data points 11, it is also possible to reveal a possible capillary collapse in the region 14, so that pores may be formed. The pores may then be detected above the capillary base in the region 15 and thus be evaluated as an unfavourable quality feature, that is to say as disadvantageous. Spiking, which causes a variation of the data points 11 in the region of the welding depth EST, may also be identified. In the keyhole shape measurement, spiking cannot always be distinguished clearly from false data points 11 due to reflections. In the measurement in the region 14, on the other hand, spiking can be clearly identified by a time resolution of the welding depth EST over the seam length and can therefore be recorded as a quality feature.

The region 16 comprises a capillary rear wall of the vapour capillary 4. A fluctuating capillary rear wall causes a wide band of data points 11 in the region 16. Large melt ejections, or spatters, result from melts which experience an upwardly directed impulse on the capillary rear wall. In the keyhole shape, the melt then gives rise to data points 11 on the capillary rear wall and above the capillary base, which may correspondingly be determined as an unfavourable quality feature.

The region 17 comprises a region of the weld pool 5 behind the vapour capillary 4. High weld pool dynamics behind the vapour capillary 4 are in turn manifested by a large height difference of the individual data points of the weld pool 5 in the region 17. The wider the data point cloud is there, the more dynamic the weld pool 5 is. In the region 17 or further behind, lastly, a seam overfill, seam collapse and seam irregularities may be evaluated by a comparison with the workpiece surface 10.

FIG. 4c once more shows the welding depth EST as a geometrical outcome variable, determined with the aid of the acquired data points 11, of FIG. 4c in a micrograph of the weld seam 3. Here, the seam width NB, which can be determined by means of the acquired data points 11, on the workpiece surface 10 and the bonding cross section AQ, which can be determined from the data points 11, between the workpiece surface 10 and the deepest location of the weld seam 3 are also shown.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for determining at least one geometrical outcome variable and/or at least one quality feature of a weld seam on at least one workpiece, the method comprising:
(a) scanning the weld seam using a measurement beam during laser beam welding of the weld seam in order to acquire data points, wherein the measurement beam is moved along at least one measurement path on the weld seam, and the acquired data points indicate a height and/or a depth of the weld seam in relation to a workpiece surface of the at least one workpiece, and
(b) determining the at least one geometrical outcome variable and/or the at least one quality feature by evaluating the acquired data points.

2. The method according to claim 1, wherein the at least one measurement path extends along a vapour capillary of the weld seam and/or along a weld pool of the weld seam.

3. The method according to claim 2, wherein the at least one measurement path extends along an unwelded part of the workpiece surface, the vapour capillary, the weld pool, and a solidified part of the weld seam.

4. The method according to claim 2, wherein the data points acquired along the vapour capillary and/or the weld pool are subdivided for the evaluation into at least two different predefined regions, which are evaluated separately.

5. The method according to claim 1, wherein the at least one measurement path extends longitudinally along the weld seam and/or transversely with respect to the weld seam.

6. The method according to claim 5, wherein the measurement beam is moved along the at least one measurement path extending longitudinally along the weld seam counter to a forward feed direction of a laser beam for generating the weld seam.

7. The method according to claim 5, wherein the measurement beam is moved alternately along a first measurement path extending longitudinally along the weld seam and a second measurement path extending transversely with respect to the weld seam.

8. The method according to claim 7, wherein the second measurement path extending transversely with respect to the weld seam is aligned with aid of the data points previously acquired along the first measurement path extending longitudinally along the weld seam, or the first measurement path extending longitudinally with respect to the weld seam is aligned with aid of the data points previously acquired along the second measurement path extending transversely along the weld seam.

9. The method according to claim 1, further comprising carrying out an adjustment calculation.

10. The method according to claim 9, wherein the adjustment calculation comprises tang of the acquired data points.

11. The method according to claim 1, wherein the at least one geometrical outcome variable is at least one of: a welding depth, a seam overfill, a weld pool length, a bonding cross section, a seam width, or a seam micrograph shape, and the at least one quality feature is at least one of: a crack, a spatter, or a pore.

12. The method according to claim 11, wherein in step (b), for the data points acquired along a solidified part of the weld seam, at least one of: an undercut or at least one seam collapse of the weld seam is determined as the at least one geometrical outcome variable and/or the at least one quality feature.

12. The method according to claim 1, wherein the acquired data points are used to readjust a laser beam during the laser beam welding.

13. The method according to claim 1, wherein the measurement beam passes through scanner optics, and wherein the measurement beam is moved along the at least one measurement path by moving at least one mirror of the scanner optics.

14. The method according to claim 1, wherein the measurement beam is an OCT measurement beam of an OCT sensor system.

15. A device for determining at least one geometrical outcome variable and/or at least one quality feature of a weld seam on at least one workpiece, wherein the device comprising:
a scanner unit adapted to scan a weld seam using a measurement beam during laser beam welding of the weld seam and to move the measurement beam along at least one measurement path on the weld seam,
an acquisition unit for acquiring data points from a scan process of the scanner unit, the acquired data points indicating a height and/or a depth of the weld seam in relation to a workpiece surface of the at least one workpiece, and
an evaluation unit for determining the at least one geometrical outcome variable and/or the at least one quality feature by evaluating the acquired data points.
